(19) United States
(12) Patent Application Publication
(10) Pub. No.: US 2008/0206401 A1
(43) Pub. Date: Aug. 28, 2008

(54) INCREASED DENSITY PET FOOD PRODUCT AND METHOD OF PRODUCTION

(75) Inventor: Mukund Parthasarathy, Wildwood, MO (US)

Correspondence Address: BELL, BOYD & LLOYD LLP, P.O. Box 1135, CHICAGO, IL, 60690, US

(73) Assignee: NESTEC LTD., Vevey (CH)

(21) Appl. No.: 12/114,617

(22) Filed: May 2, 2008

Related U.S. Application Data
(63) Continuation of application No. 10/271,902, filed on Oct. 16, 2002, now abandoned.

(51) Int. Cl. A23K 1/00; A23L 1/186

(52) U.S. Cl. 426/28; 426/635; 426/53

(57) ABSTRACT

An increased density dry pet food product is provided having a bulk density of 25 to pounds per cubic food, residual α-amylase activity in the range of 0.1 to 57 NU per gram of the pet food product, and having a maintained or increased softness. A method of producing the dry pet food product is also provided.

### TECHNICAL FIELD

This invention relates generally to pet food products and, specifically, to a dry pet food product having increased density and containing an active thermal-stable amylase in an amount sufficient to cause an increase in the bulk density of the product.

### BACKGROUND OF INVENTION

Pet food products are generally divided into three categories: dry, semi-moist, and canned. Although there are no industry standards, dry pet foods typically have a moisture content of less than 15% by weight and generally have a dry, hard texture. Semi-moist foods typically have a moisture content in the range of 15 to 50% by weight. Canned foods generally have a moisture content of above 50%, and often around 70% by weight. The development and production of various pet food products in these three categories is well known in the art. Pet food products such as cat and dog foods have been known for years, and those skilled in the art are aware of multiple formulations and processes for preparing such products. There remain, however, continuing problems within the art.

Pet food products are typically sold by weight. The bulk density of a dry pet food product therefore has important commercial implications. A dry product having a relatively high bulk density can be stored in a smaller bag or other container than can its low bulk density counterpart, even though the total weight of food product stored is the same. High bulk density reduces packaging costs to the manufacturer. Further, the high bulk density product requires less warehouse space for storage and often takes less shelf space at the retail level. Thus, there is a need for relatively high-density pet food products that are well tolerated by animals.

There are, however, factors that complicate attempts to provide high bulk density dry pet food products. Namely, as the bulk density of the food product increases without the addition of fat, emulsifiers, or a combination of both and other additives such as gums or hydrocolloids, the product becomes harder. If water alone is used as a medium to increase bulk density, the product becomes hard. If the product becomes too hard it may not be acceptable to cats or dogs. Thus, there is a need to provide a pet food product having an increased bulk density that retains a degree of softness required for the product to serve as a suitable animal food source. There is also a need to provide such a product that resists staling so that the softness of the product does not deteriorate too swiftly over time.

There have been attempts in the art to solve the problem of providing a high bulk density, dry animal food, and there have also been attempts to provide soft pet food products that to some degree resist staling. Each of these previous attempts differs from the approach of the present invention.

U.S. Pat. No. 4,540,585, issued to Priegnitz, teaches a semi-moist pet food product containing α-amylase. According to the disclosure, the finished food product has a moisture content of about 50%. Priegnitz further teaches that α-amylase activity occurs only at moisture levels above approximately 15%. The finished food product of Priegnitz has a bulk density of 31 to 32 pounds per cubic foot (38.6 to 40 pounds per bushel). Priegnitz also discloses the use of α-amylase to improve the softness of semi-moist pet foods. To Applicant's knowledge, it is unknown to add α-amylase to a dry animal food to improve softness.

U.S. Pat. No. 4,393,085, issued to Spradlin et al., teaches enzyme digestion of a dog food product. Spradlin et al. teaches a process for use with food products having moisture contents of greater than 15%. Spradlin et al. further teaches a two enzyme system, e.g. amylase and protease, for treatment of a dog food product, and teaches heat-inactivation of the enzymes during product production. Obviously, a process using two enzymes is more expensive than a process using a single enzyme. It is well known that protease is more expensive than α-amylase. In the pet food industry, cost is an important factor.

U.S. Pat. No. 4,810,506, issued to Lewis et al., describes a process for treating grain products involving subjecting parboiled grain products to treatment with an enzyme solution. Lewis et al. disclose the use of an α-amylase as the enzyme to which the grain is subjected. According to the teachings of Lewis et al., the enzyme treatment decreases the density of the grain product, resulting in a light-weight product.

U.S. Pat. No. 3,617,300, issued to Borochoff et al., teaches a process for in situ conversion of starch. The process uses α-amylase and amyloglucosidase to convert starch to dextrose within an amylaceous system. Borochoff et al. teach that the product must have a minimum moisture level of around 25% in order for the enzymatic reaction to take place. Borochoff et al. further teach that the temperature must remain below around 90° C. (194° F.) in order for the enzymatic reaction to proceed, and that the higher temperature results in heat-inactivation of the enzyme. Again, a process using two enzymes is more expensive to use than a process using a single enzyme. It is known that amyloglucosidase is more expensive than α-amylase.

### SUMMARY OF INVENTION

Dry pet food products are commonly produced in particle or kibble form using an extrusion process. The moisture content in the finished product is typically less than 15% for dry pet foods. These dry pet food products also generally have a starch content of between 15 and 40% due to the use of various grains like corn in the formulations. The present invention provides an increased bulk density dry pet food product, and method for producing the same. The increased density of the present food product is accomplished, in part, by the addition of a thermal-stable amylase to the food product ingredients during production. The α-amylase employed in this invention generally has a residual activity in the range of 0.1 to 57 NU per gram of finished product, while the pet food contains a moisture content of approximately from about 8 to about 11%. Thus the present invention provides a dry pet food having a bulk density above 25 pounds per cubic foot and typically in the range of from about 25 to about 31 pounds per cubic foot (31 to 38.5 pounds per bushel).

The present invention also provides an improved method for production of the above dry pet food product. It has been discovered that the method of this invention achieves greater efficiency of production, particularly in the conservation of energy required to produce the extruded form of the dry pet food. Because of the increased efficiency in the extrusion process, the present invention also leads to costs savings during the manufacturing process.

### BRIEF DESCRIPTION OF DRAWING

FIG. 1 is a schematic illustration of the preconditioner and extruder used to produce the dry pet food product of the present invention.

### DETAILED DESCRIPTION

An increased density pet food product having a maintained or improved softness is produced by addition of an effective amount of α-amylase to the pet food product.

α-Amylase is a well-known enzyme. It has an IUBMB number of 3.2.1.1. The enzyme catalyzes the endohydrolysis of 1,4,-α-D-glucosidic linkages in polysaccharides containing three of more 1,4-α-linked D-glucose units. α-Amylase can be derived from fungal, cereal, or bacterial sources. Fungal α-amylase is temperature sensitive, generally becoming deactivated at approximately 60-65° C. (140-149° F.). Certain bacterial amylases have higher thermal stability and can withstand temperatures of up to 110° C. (230° F.). The addition of amylase to starches breaks the starches down into soluble dextrins and oligosaccharides. The addition of amylase to the formulation of a dry pet food product causes the breakdown of some of the starches in the formulation to sugars that do not expand after extrusion. As a result, higher bulk density kibbles are produced. Use of a heat-stable amylase allows for residual enzyme activity in the food product after production, and thus provides increased softness and shelf-life for the product.

The method of the present invention comprises starting with a dry mix having at least one amylaceous ingredient, adding water and/or steam to produce a wet mix, adding an effective amount of thermal-stable α-amylase to the wet mix, allowing the α-amylase to react with the wet mix for a period of time sufficient to produce an end-product having a bulk density in the range of 24.9 to 30.9 pounds per cubic foot (31 to 38.5 pounds per bushel), cooking the wet mix sufficiently to inactivate some, but not all, of the α-amylase in the wet mix, and drying the food product to a moisture content in the range of 8 to 11%.

The amount of α-amylase suitable for use in the present invention may vary depending on the precise ingredients used for a particular pet food product, or the precise process used to product the pet food product. Generally, a range of approximately 60 to 0.6 KNU (1140 to 11400 SKB units) of enzyme is added for each kilogram of dry meal. Units of enzyme herein are given in both KNU, the measure of activity used by the manufacturer of the α-amylase used in the present examples, and SKB units, which are an older measure of amylase activity known in the art and set forth in Sanstedt, et al., Cereal Chemistry, Vol. 16, page 712 (1939). Factors that influence the amount of enzyme used in practicing the present invention may include the moisture content of the food product, the activity of the enzyme, calcium levels, chloride levels, the pH of the product, the temperature of the product, the amount of starch in the product, and the time available to the enzymatic reaction given various process parameters. Each of these parameters can influence the rate and degree of enzymatic activity. Most pet food products contain sufficient calcium and chloride to activate the enzyme. If suitable amounts of these ions are not present in the pet food product, they may be added in the form of suitable edible salts.

The precise reaction conditions and process parameters used for producing a pet food product in accordance with the teachings of the present invention may vary depending on the type of pet food product being produced and the specific α-amylase being used. As the temperatures involved in the production process may vary depending on the type of pet food product being produced, an α-amylase that is stable within process parameters should be selected.

As with temperature, the pH of the product may vary according to the specific pet food product being produced. An α-amylase should be selected that reacts effectively at pH levels encountered during the process.

It is important to note that the starch in the pet food product must be gelatinized before α-amylase is able to act on it. Thus, the pet food product must be subjected to a sufficient temperature, and for a sufficient time, to gelatinize the starch. The temperature and time must not be so great, however, as to inactivate the α-amylase. To that end, a heat-stable α-amylase is preferable to one that cannot withstand high temperatures.

A preferred α-amylase for the purposes of the present invention is a bacterial α-amylase (1,4-α-D-glucano-hydrolase) produced from Bacillus licheniformis. This α-amylase can be obtained from Novozymes of Franklinton, N.C., and is sold under the brand name Termamyl® 120L, Type L. This particular α-amylase is active at temperatures of up to 105-110° C. The present invention, using a single enzyme, is less expensive than some prior art techniques. A pet food product with increased bulk density is less costly to package and store than a lower density product. A dense, dry pet food that is also soft may be better accepted by animals

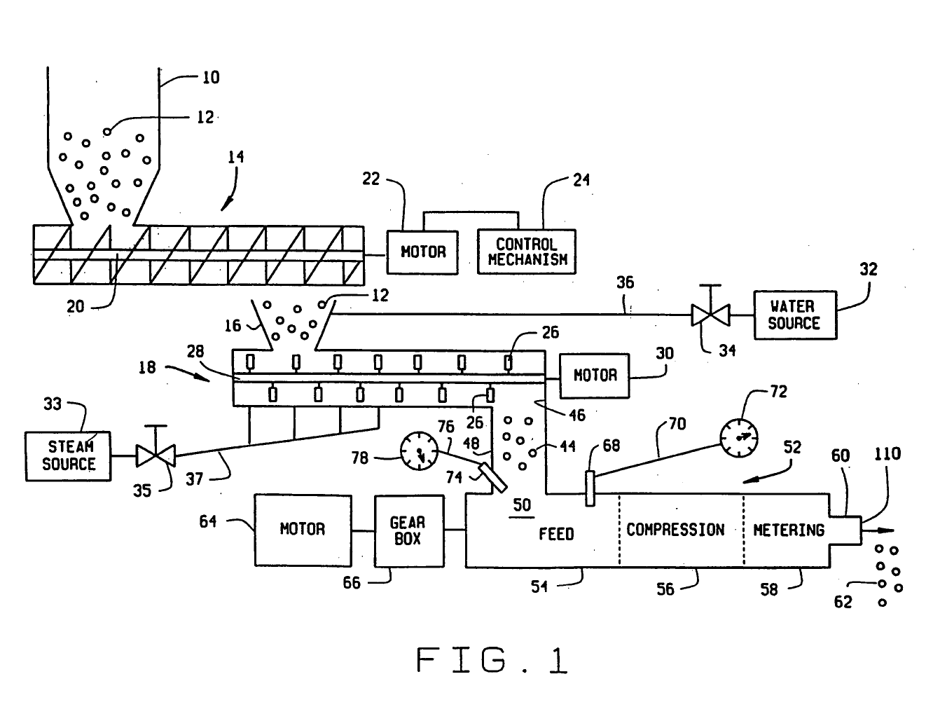

Referring now to FIG. 1, a schematic illustration of the process for producing the dry pet food product of the present invention is shown. Dry ingredients 10, including at least one amylaceous ingredient and generally composed of farinaceous ingredients, proteinaceous ingredients and dry vitamins and minerals and the like, are delivered from a bin 12 or other suitable device and are mixed in a suitable mixing device 14. Suitable farinaceous ingredients are wheat, corn, barley, oats, and the like, generally in dry meal forms. Also suitable is ground corn, whole-wheat flour, brewers rice, or other grains and cereals. The dry proteinaceous ingredients are generally obtained from meat or vegetable sources. Suitable ingredients include corn gluten meal, poultry by-product meal, soybean meal, fish meal, animal digest, and calcium choline chloride. Dry vitamin ingredients can include vitamins E, A, B-12, D-3, riboflavin, niacin, calcium pantothenate, biotin, thiamine mononitrate, folate, pyridoxine hydrochloride, menadione sodium bisulfate complex (a source of vitamin K), and others. Minerals may include potassium chloride, calcium carbonate, calcium chloride, dicalcium phosphate, sodium chloride, zinc sulfate, ferrous sulfate, manganese sulfate, copper sulfate, calcium iodate, and sodium selenite, among others. It is to be understood that the dry ingredients enumerated above do not constitute a exhaustive list. Any suitable combination of dry ingredients may be used, and such dry ingredients may vary depending on the type of animal for which the food is being produced.

Just prior or subsequent to the introduction of dry ingredients 10 into a preconditioner 16, a heat stable α-amylase is delivered from an enzyme source 18 and is contacted with dry ingredients 10. The enzyme is preferably added at a rate of 0.05 to 0.5% of the weight of dry meal per hour and the addition of enzyme is controlled by valve 38, which allows flow of the enzyme solution along line 40. Any thermal-stable α-amylase capable of withstanding the temperatures of the present process may be used, but a preferred α-amylase is sold under the trademark Termamyl® 120L, by Novozymes, Inc., Denmark, and is described above. This a-amylase is stable at operating temperatures of 105 to 110° C. and has an activity, as sold, of 120 KNU/g (2.28×10³ SKB units/g). The enzyme is sold in aqueous solution and is contacted, in liquid form, with the dry ingredients of the present invention. The enzyme is preferably added to a concentration of from about 60 KNU per kilogram of dry meal to about 600 KNU per kilogram of dry meal (1140 SKB units per kilogram of dry meal to 11400 SKB units per kilogram of dry meal).

Inside preconditioner 16, water 20 and/or stream 22 is added to produce a semi-moist wet mix 26. The addition of water 20 and/or steam 22 is controlled by valves 42 and 44, respectively, which allow for the flow of water 20 and steam 22 along lines 46 and 48, respectively. Wet mix 26 preferably has a moisture content of 22 to 29% as determined by a moisture sensor 24 inside of preconditioner 16. Wet mix 26 is retained within preconditioner 16 for approximately 5 seconds, and no longer than 20 seconds, which is sufficient to moisten and begin cooking the mixture which will achieve a temperature of about 93.3° C. (200° F.) upon exit from preconditioner 16.

Wet mix 26 then moves into an extruder 28 wherein it is cooked for a sufficient time and at a sufficient temperature to cook the food product while leaving at least some of the α-amylase active. The minimum retention time inside extruder 28 is approximately 30 to 60 seconds, and preferably no more than 300 seconds. The temperature inside extruder 28 is generally in the range of 93.3 to 110° C. The extrudate is cut into particles 34 called ‘kibbles’ by passing it through a die cap 30 and cutting it with a spinning knife 32. After the kibbles are extruded, the starch component tends to expand, thereby reducing the bulk density of the final product. The α-amylase used in the present invention converts some, but not all, of the starches to simple sugars. Because there is less starch in the final product it expands less after extrusion.

The particles 34 are transferred to a dryer (not shown), wherein they are dried to a final moisture content of approximately 8 to 11%. The drying temperature is preferably in the range of 71 to 148° C. (160-300° F.). The retention time in the dryer is generally approximately 20 to 30 minutes, and preferably no longer than 180 minutes. By the end of the drying step, when the product is ready for packaging, at least some of the α-amylase enzyme is still active and the product has a bulk density in the range of 24.9 to 30.9 pounds per cubic foot (31 to 38.5 pounds per bushel). The moisture content of the finished product is approximately 8 to 11%, and preferably 7.5% by weight.

Each of the above devices, such as mixing device 14, preconditioner 16 and extruder 28, are powered by motors and under the control of control systems that are well known in the art. Mixing device 14 is powered by motor 50 and under the control of control mechanism 52. Preconditioner 16 is powered by motor 54 and under the control of control mechanism 56, and extruder 28 is powered by motor 60 and under the control of control mechanism 58. Control of extruder 28 is also regulated by gear box 62.

### EXAMPLES

The following examples are presented for the purpose of further illustrating and explaining the present invention. The examples are not intended to in any way limit the scope of the present invention.

Examples 1 and 2 describe the preparation of similar dry cat food products, with the difference being that example 1 describes a prior art cat food product not prepared by the addition of α-amylase in accordance with the present invention, and example 2 describes a cat food product prepared in accordance with the teachings of the present invention.

### Example 1

### Prior Art Cat Food

A dry cat food is produced in accordance with a prior art technique using the following formula:

| Ingredient | Amount by Weight |
|---|---|
| Farinaceous components | 44% |
| Proteinaceous components | 46% |
| Fat | 7% |
| Flavorings | 2% |
| Vitamins, minerals and essential fatty acids | 1% |

The dry farinaceous components, dry proteinaceous components, dry vitamins, minerals and essential fatty acids were fed into a 16-inch preconditioner at approximately 4,000 pounds/hour. This flow rate is sometimes referred to as the “dry meal feed rate.”

The preconditioner used in the present example was a 16″ diameter wet mixer or preconditioner having a length of approximately 9 feet. Water and/or steam was added in the preconditioner to raise the moisture content to approximately 28% by weight of the other components (this is sometimes referred to as the “condensed meal moisture”). The temperature of the meal in the preconditioner was about 93° C. (200° F.). The meal retention time in the preconditioner was about 5 seconds.

Next, the preconditioned meal moved into an extruder having a diameter of about 7 inches and a length of about 10 feet with a 200 plus horsepower motor. The motor driving the extruder uses 483 volts, 3 phase, AC current and draws about 130 amps. The throughput of the extruder is about 5,000 pounds per hour, which is sometimes referred to as the “wet production rate.” The meal retention time in the extruder was approximately 30 to 60 seconds. The inside extruder temperature and the temperature of the extrudate was approximately 95.5° C. (204° F.). The cooling jacket water temperature was approximately 53.8° C. (129° F.). After passing through a die cap, the extrudate was cut into particles (sometimes called kibbles) with a spitting knife.

The particles were then transferred to a dryer having a temperature of 71 to 148° C. (160 to 300° F.). The retention time in the dryer for the particles was approximately 30 minutes.

Next, the dry cat food was coated with tallow and acid flavorings. The finished product had a moisture content of approximately 7.5% by weight. The average energy required to break the kibble of this prior art product was 12.34 foot pounds. The shelf life of the dry cat food produced in this example was approximately 18 months. The caloric content (metabolizable energy) of the dry cat food produced in this example was approximately 1648 Kcal/lb.

The chemical analysis of this finished dry cat food is approximately as follows:

| Ingredient | Amount by Weight |
|---|---|
| Crude Protein | 31.5-34.5% |
| Starch | 30.0-35.0% |
| Crude Fat | 11.0-14.5% |
| Crude Fiber | 4.5% |
| Moisture | 12% |
| Linoleic acid | 1.25% |
| Arachidonic acid | 0.02% |
| Calcium | 1.1% |
| Phosphorous | 0.9% |
| Taurine | 0.125% |

This finished dry cat food product has a density of about 23.3 pounds per cubic foot (29 pounds per bushel).

### Example 2

### Dry Cat Food Produced in Accordance with the Present Invention

A dry cat food is produced in accordance with the present invention using the following formula:

| Ingredient | Amount by Weight |
|---|---|
| Farinaceous components | 44% |
| Proteinaceous components | 46% |
| Fat | 7% |
| Flavorings | 2% |
| Vitamins, minerals and essential fatty acids | 1% |

The dry farinaceous components, dry proteinaceous components, dry vitamins, minerals and essential fatty acids were fed into a 16-inch preconditioner at a dry meal feed rate of approximately 4,000 pounds/hour. Inside the preconditioner, an aqueous solution containing a-amylase was contacted with the dry ingredients. The α-amylase used was Termamyl® 120L, Type L, obtained from Novozymes, Franklinton, N.C. The enzyme is sold with an activity of 120 KNU/g (2.28×10³ SKB units/g), however a 1:10 dilution was performed prior to contacting the enzyme solution with the dry ingredients. The application rate of the enzyme solution was 0.5% of the weight of the dry ingredients per hour.

The preconditioner used in the present example was a 16″ diameter wet mixer or preconditioner having a length of approximately 9 feet. Water and/or steam was added in the preconditioner to raise the condensed meal moisture to approximately 28% by weight of the other components. The temperature of the meal in the preconditioner was about 93° C. (200° F.). The meal retention time in the preconditioner was about 5 seconds.

Next, the preconditioned meal moved into an extruder having a diameter of about 7 inches and a length of about 10 feet with a 200 plus horsepower motor. The motor driving the extruder uses 483 volts, 3 phase, AC current and draws in the range of from about 116 amps. The throughput, or wet production rate, of the extruder was about 5,000 pounds per hour. The meal retention time in the extruder was approximately 45 seconds. The inside extruder temperature and the temperature of the extrudate was approximately 110° C. (230° F.). The cooling jacket water temperature was approximately 60° C. (140° F.). After passing through a die cap, the extrudate was cut into particles (sometimes called kibbles) with a spitting knife.

The particles were then transferred to a dryer having a temperature of 148° C. (300° F.). The retention time in the dryer for the particles was approximately 30 minutes.

Next, the dry cat food was coated with tallow and acid flavorings. The finished product had a moisture content of approximately 7.5% by weight. The average energy required to break the kibble of this cat food produced in accordance with the teachings of the present invention is 10.27 foot pounds. The shelf life of the dry cat food produced in this example was approximately 18 months. The caloric content (metabolizable energy) of the dry cat food produced in this example was approximately 1760 Kcal/lb.

The chemical analysis of this dry cat food is approximately as follows:

| Ingredient | Amount by Weight |
|---|---|
| Crude Protein | 31.5-34.5% |
| Starch | 30.0-35.0% |
| Crude Fat | 11.0-14.5% |
| Crude Fiber | 4.5% |
| Moisture | 12% |
| Linoleic acid | 1.25% |
| Arachidonic acid | 0.02% |
| Calcium | 1.1% |
| Phosphorous | 0.9% |
| Taurine | 0.125% |

The bulk density of this dry cat food product is from about 26.5 pounds per cubic foot (33 pounds per bushel).

The α-amylase used in the present invention costs about $3.50-$10.00 per ton of finished pet food. This is more economical than some prior art techniques. The α-amylase is only partially inactivated by processing temperatures and maintains an activity of 0.1-57 Novo units/gram in the finished product.

Further product was produced at two other enzyme levels. These two processes included the following parameters:

| Enzyme | DMR | CMM | AMPS | BD |
|---|---|---|---|---|
| 0.1 | 4037 | 28 | 102 | 28.5 |
| 0.25 | 3990 | 28 | 87 | 32.6 |

where enzyme levels are given in percent of dry ingredients per hour; DMR=dry meal rate in pounds/hour; CMM=condensed meal moisture in percent by weight of product; AMPS=amperes of current drawn by extruder; and BD=bulk density of finished product in pounds per cubic foot. Increased rates of enzyme application correlates with increased bulk density of the finished product.

### Example 3

### Dry Dog Food Produced in Accordance with the Present Invention

A dry dog food is produced in accordance with the present invention using the following formula:

| Ingredient | Percent by Weight |
|---|---|
| Farinaceous components | 60.19 |
| Proteinaceous components | 28.0 |
| Fat | 6.8 |
| Flavorings | 0.01 |
| Vitamins, minerals and essential fatty acids | 5.0 |

The dry farinaceous components, dry proteinaceous components, dry vitamins, minerals and essential fatty acids were fed into a 16-inch preconditioner at a dry meal feed rate of approximately 4506 pounds/hour. Inside the preconditioner, an aqueous solution containing α-amylase was contacted with the dry ingredients. The α-amylase used was Termamyl® 120L, Type L, obtained from Novozymes, Franklinton, N.C. The enzyme is sold with an activity of 120 KNU/g (2.28×10⁶ SKB units/g), however a 1:10 dilution was performed prior to contacting the enzyme solution with the dry ingredients. The application rate of the enzyme solution was 0.05% of the weight of the dry ingredients.

The preconditioner used in the present example was a 16″ diameter wet mixer or preconditioner having a length of approximately 9 feet. Water and/or steam was added in the preconditioner to a condensed meal moisture of approximately 28.4% by weight of the other components. The temperature of the meal in the preconditioner was about 93° C. (200° F.). The meal retention time in the preconditioner was about 5 seconds.

Next, the preconditioned meal moved into an extruder having a diameter of about 7 inches and a length of about 10 feet with a 200 plus horsepower motor. The motor driving the extruder uses 4.83 volts, 3 phase, AC current and can draw up to about 99 amps. The wet production rate of the extruder was about 7300 pounds per hour. The meal retention time in the extruder was approximately 30 seconds. The inside extruder temperature and the temperature of the extrudate was approximately 100° C. (212° F.). The cooling jacket water temperature was approximately 55.5° C. (132° F.). After passing through a die cap, the extrudate was cut into particles (sometimes called kibbles) with a spitting knife.

The particles were then transferred to a dryer having a temperature of 148° C. (300° F.). The retention time in the dryer for the particles was approximately 30 minutes.

Next, the dry dog food was coated with tallow and acid flavorings. The finished product had a moisture content of approximately 9.7% by weight. The finished product required 17.34 foot pounds of energy to break the kibble as measured on Instron. The shelf life of the dry dog food produced in this example was approximately 18 months. The caloric content (metabolizable energy) of the dry dog food produced in this example was approximately 1679 Kcal/lb.

The chemical analysis of this dry dog food is approximately as follows:

| Ingredient | Percent by Weight |
|---|---|
| Crude Protein | 22.4 |
| Starch | 51.7 |
| Crude Fat | 11 |
| Crude Fiber | 1.57 |
| Moisture | 9.76 |
| Linoleic acid | 1.55 |
| Arachidonic acid | 0.02 |
| Calcium | 1.11 |
| Phosphorous | 0.89 |
| Taurine | 0.03 |

The bulk density of this dry dog food product was about 28.1 pounds per cubic foot (35 pounds per bushel).

Further product was produced at two other enzyme levels. These two processes included the following parameters:

| Enzyme | DMR | CMM | AMPS | BD |
|---|---|---|---|---|
| 0.1 | 4497 | 28.1 | 90.3 | 31.1 |
| 0.25 | 4508 | 28.3 | 79.3 | 35.0 |

where enzyme levels are given in percent of dry ingredients per hour; DMR=dry meal rate in pounds/hour; CMM=condensed meal moisture in percent by weight of product; AMPS=amperes of current drawn by extruder; and BD=bulk density of finished product in pounds per cubic foot. Increased rates of enzyme application correlates with increased bulk density of the finished product.

The α-amylase used in the present invention costs about $3.50-$10.00 per ton of finished pet food. This is thought to be more economical than some prior art techniques. The alpha-amylase is only partially inactivated by processing temperatures and maintains an activity of 0.1-57 Novo units/gram in the finished product.

Thus, there has been shown and described various embodiments of a dry pet food product produced in accordance with the teachings of the present invention. Many changes, modifications, and variations of the present invention will, however, become apparent to those skilled in the art after considering this specification. All such changes, modifications, and variations that do not depart from the spirit and scope of the present invention are deemed to be covered by the invention, which is limited only by the claims that follow.

1-7. (canceled)

8. A dry pet food comprising less than 15%, by weight, water and thermal-stable α-amylase and having a bulk density above about 25 pounds per cubic foot, wherein the α-amylase is produced from bacillus licheniformis.

9. A dry pet food product comprising less than 15%, by weight, water and thermal-stable α-amylase having an activity in the range of from about 0.1 to about 57 NU per gram of said pet food product, wherein the α-amylase is produced from bacillus licheniformis, said pet food product having a bulk density above about 25 pounds per cubic foot.

10. A dry pet food comprising less than 15%, by weight, water, thermal-stable α-amylase having an activity in the range of from about 0.1 to about 57 NU per gram of said pet food product, wherein the α-amylase is produced from bacillus licheniformis, said pet food product having a bulk density above about 25 pounds per cubic foot and an Instron local peak force value of below about 13 pounds per foot.

11. A dry pet food comprising:
a) crude protein in the range of from about 21 to about 35% by weight;
b) crude fat in the range of from about 10 to about 14% by weight;
c) water in the range of from about 8 to about 11% by weight; and
d) thermal-stable α-amylase, added to an extruder, having an activity in the range of from about 0.1 to about 57 NU per gram of said pet food product, wherein the α-amylase is produced from bacillus licheniformis, said pet food product having a bulk density above about 25 pounds per cubic foot and a softness below about 14 pounds per foot on the Instron scale.

12. A method of making a dry pet food product, the method comprising:
a) mixing dry ingredients comprising at least one amylaceous ingredient;
b) performing either of steps i) or ii), below;
i. adding sufficient water to the dry ingredients from step a, above, to produce a wet mixture of ingredients having from about 22 to 29% total moisture;
ii. adding to the dry ingredients from step a or to the wet mixture from step i, above, an effective amount of a thermal-stable α-amylase, wherein the α-amylase is produced from bacillus licheniformis;
c) performing the one of steps i) or ii), above, not previously performed;
d) cooking the wet mixture in an extruder for a time and a temperature such at that least some of the α-amylase remains active in the cooked food product; and
e) drying the cooked food product until said food product has a moisture content of from about 8 to about 11% by weight and a bulk density of above about 25 pounds per cubic foot.

13. A method of making a dry pet food product, the method comprising:
a) combining dry ingredients, said dry ingredients having at least one farinaceous ingredient, water and a thermal-stable α-amylase to form a wet mixture, wherein the α-amylase is produced from bacillus licheniformis;
b) cooking the wet mixture in an extruder for a time and at a temperature such at that least some of the α-amylase remains active in the cooked food product; and
c) drying the cooked food product until said food product has a moisture content of from about 8 to about 11% by weight and a bulk density of above about 25 pounds per cubic foot.

14. A method of making dry pet food product, the method comprising:
a) combining dry ingredients, said dry ingredients having at least one farinaceous ingredient, water;
b) adding to the dry ingredients of step a) a thermal-stable α-amylase in an aqueous solution to form a wet mixture, wherein the α-amylase is produced from bacillus licheniformis;
c) cooking the wet mixture in an extruder for a time and at a temperature such at that least some of the α-amylase remains active in the cooked food product; and
d) drying the cooked food product until said food product has a moisture content of from about 8 to about 11% by weight and a bulk density of above about 25 pounds per cubic foot.
